(19) United States
(12) Patent Application Publication
(10) Pub. No.: US 2013/0220135 A1
(43) Pub. Date: Aug. 29, 2013

(54) HOT BEVERAGE PREPARATION DEVICE COMPRISING A DATA TRANSMISSION UNIT

(71) Applicants: Ralf Aigner, Kienberg (DE); Florian Hoeck, Siegsdorf (DE); Robert Strobl, Unterwossen (DE)

(72) Inventors: Ralf Aigner, Kienberg (DE); Florian Hoeck, Siegsdorf (DE); Robert Strobl, Unterwossen (DE)

(73) Assignee: BSH BOSCH UND SIEMENS HAUSGERÄTE GMBH, Munich (DE)

(21) Appl. No.: 13/881,376

(22) PCT Filed: Nov. 2, 2011
(86) PCT No.: PCT/EP2011/069223

§ 371 Date: Apr. 25, 2013

(30) Foreign Application Priority Data
Nov. 12, 2010 (DE) 10 2010 043 858.8

(51) Int. Cl. A47J 31/44

(52) U.S. Cl. CPC A47J 31/4403
USPC 99/285

(57) ABSTRACT

A hot beverage preparation device, in particular a fully automatic coffee maker, can be operated in a normal operating mode for preparing hot beverages and in a data transmission mode for transmitting data to a receiver. The hot beverage preparation device includes an encoding unit for encoding the data to form at least one encoded data record in a machine-readable code and a display unit for displaying the encoded data record.

The invention relates to a hot beverage preparation apparatus, in particular a fully automatic coffee maker, which is configured for preparing hot beverages in a normal operating mode and for transmitting data to a receiving device in a data transmission mode.

Hot beverage preparation apparatuses, such as fully automatic coffee makers for example, have an internal fault memory for storing deviations from operating parameters and faults that occur during operation. If a fault occurs, which adversely affects or even blocks the operation of the hot beverage preparation apparatus, an operator is informed about it by means of status information (e.g. a display). Depending on the cause of the message, the operator can either eliminate the fault him/herself or is requested to inform the customer service department. The customer service department can read out the fault memory for example by way of a service interface of the hot beverage preparation apparatus. Alternatively a message appears in the display to call the customer service department and give notification of the fault number or code shown in the display. The customer service department can then either provide advice by telephone so that the operator can eliminate the fault, arrange for collection of the defective hot beverage preparation apparatus or send an employee out. The possibility of misdiagnosis by telephone however always depends on the technical understanding of the operator and his/her willingness to assist. If the hot beverage preparation apparatus is with the customer service department or the latter is on site, it is possible to obtain an accurate picture of the cause of the fault by reading out the fault memory. However this requires a laptop and a diagnostic tool for connection to the hot beverage preparation apparatus.

The object of the invention is therefore to simplify determination of the cause of the fault.

With a hot beverage preparation apparatus of the type mentioned in the introduction this object is achieved in that an encoding unit is provided to encode the data to form at least one encoded data record in a machine-readable code and a display unit is provided to display the encoded data record. The encoding of the data record in a machine-readable code allows direct forwarding and processing of the information contained in the data record, without an operator having to be involved in between to forward or interpret a fault code. This reduces transmission errors, as can occur with manual transmission. Rather it follows the principle of generating and outputting a data record that has been encoded in a machine-readable manner and can be processed directly by receiving devices which then name the cause of a fault for example in comprehensible form. Conversely further information can also be supplied in a simple manner if required, for example by means of software updates for the receiving devices, relating for example to further fault sources which only occur during the service life of the product after the product has been brought into use.

According to one advantageous embodiment of the invention the encoded data record is encoded using a graphic code, in particular a 2D code. An optoelectronically readable 2D code or 2D barcode for example is therefore used, which consists of lines or dots of differing widths with gaps in between. The data of the data record is encoded in the form of an area over two dimensions, which allows a higher information density to be achieved per unit of area. Such codes can be read in using receiving devices, which have optical read devices such as camera scanners. The receiving devices can be mobile telephones, in particular smart phones.

In one advantageous embodiment of the invention the data in the encoded data record can be arranged in matrix form, one-dimensionally in a number of rows or in circles. The codes used can be for example stacked codes such as Codablock, code 49, PDF417 or matrix codes such as QR code, DataMatrix, MaxiCode, Aztec code.

According to a further advantageous embodiment of the invention the data can be measurement values from sensors of the hot beverage preparation apparatus and/or fault codes identifying its malfunctions and/or operating parameters of the hot beverage preparation apparatus. This allows the function of sensors to be checked in a simple manner, in other words without disassembling the hot beverage preparation apparatus. The sensors can be for example sensors for detecting the throughflow quantity, temperature, electrical voltage or electrical current for detecting fill levels of operating means, such as water for example. It is therefore possible to check the functional capability of the sensors in a simple manner. Transmitting fault codes, which identify certain malfunctions of the hot beverage preparation apparatus, further simplifies diagnosis in the event of a fault. The automatic diagnosis capability of the hot beverage preparation apparatus is used for this purpose, allowing malfunctions, for example due to a component failure, to be detected by means of a controller of the hot beverage preparation apparatus and a corresponding fault code to be assigned. The transmission of operating parameters such as the number of brewing cycles, the throughflow quantity, the number of descaling operations, read out barcodes of beverage preparation capsules and/or prepared hot beverages allows data to be provided about how long it has been since the last maintenance or the strain to which the hot beverage preparation apparatus has been exposed. A large amount of data can thus be provided if required, allowing a precise diagnosis of the causes of faults.

According to a further advantageous embodiment of the invention the encoded data record can contain a recipient address. The recipient address can be an email address, a telephone number for receipt of an SMS for example, a link for establishing an internet connection or a vCard with information in the form of name, telephone number, email address. This allows automatic forwarding to the customer service department, in particular with the assistance of corresponding receiving devices, without an operator having to determine such contact data.

According to a further advantageous embodiment of the invention the encoded data record can be used for mobile tagging. In this process an encoded data record is read out using a receiving device. Read software or a reader of the receiving device then decrypts the encoded data record and forwards decrypted data to the web address or service telephone number contained in the encoded data record, for example for receipt of an SMS. There is no need for manual and therefore error-prone transmission of the web address or service telephone number.

This simplifies contact with the customer service department, as the laborious inputting of an internet address or service telephone number is dispensed with because this information is already contained in the encoded data record and the receiving device is set up to process such information, for example by means of a corresponding software module. It is therefore also possible to update internet addresses and/or service telephone numbers in a simple manner after any change, as such updated information can be stored and assigned in the software module. There is therefore no need to update such information in the hot beverage preparation apparatus itself.

According to a further advantageous embodiment of the invention the display unit can be a display. With such a display, which has a plurality of image points that are arranged in lines and rows and can be activated individually and independently of one another, it is possible to display the encoded data records and, if these are not required, also to use the display for other purposes, for example to display other operating parameters during intended use. To this end such a display can have a minimum size of for example 177×177 image points.

The display is preferably a TFT display, thereby ensuring that the encoded data records are shown with sufficient contrast to allow error-free reading in.

To increase the quantity of data, the display unit can preferably be configured to display a number of encoded data records in time sequence. This allows displays to be used which have a resolution that is not adequate to display the necessary quantity of data of an encoded data record at one time. The quantity of data is then distributed between a number of data records, which are displayed one after the other using the display.

The hot beverage preparation apparatus preferably also has a data memory for storing measurement values from sensors of the hot beverage preparation apparatus and/or fault codes identifying its malfunctions and/or operating parameters of the hot beverage preparation apparatus. The data memory thus allows the displaying of a number of data records one after the other in a time sequence, these being encoded one after the other according to the maximum quantity of data that can be displayed.

The principle of the invention is described in yet more detail below based on an example with reference to a drawing, in which:

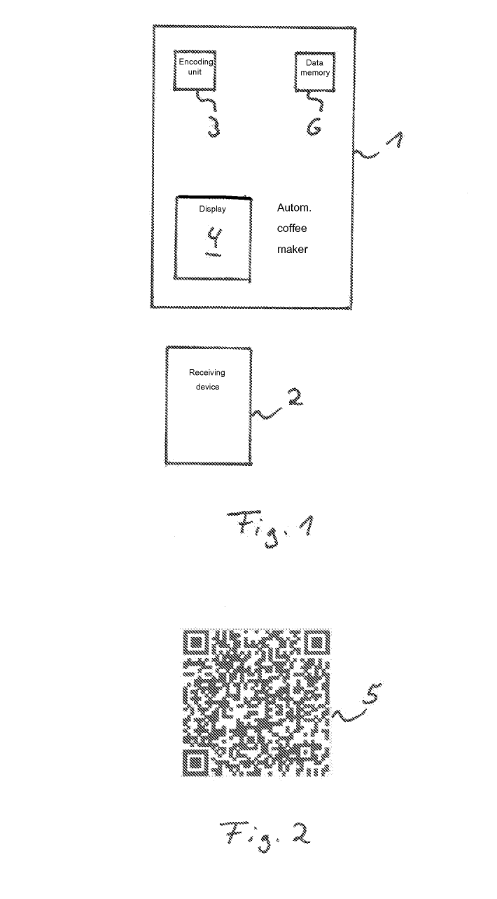

FIG. 1 shows a schematic diagram of a first exemplary embodiment of an inventive hot beverage preparation apparatus in conjunction with a receiving device, and

FIG. 2 shows a schematic diagram of an encoded data record.

A fully automatic coffee maker 1 is shown as an exemplary embodiment of a hot beverage preparation apparatus. So that an operator can operate the fully automatic coffee maker 1, operating means (not shown) are provided to switch the fully automatic coffee maker 1 on and off and to select an operating program for preparing a specified hot beverage, for example espresso, from a plurality of operating programs for preparing different hot beverages.

The fully automatic coffee maker 1 has a display unit 4, in the present exemplary embodiment a TFT display. The TFT display can display for example the selection of an operating program and then progress with the preparation of a hot beverage for an operator in this normal operating mode.

However if a controller (not shown) of the fully automatic coffee maker 1, which activates and monitors different units of the fully automatic coffee maker 1 during the course of the selected operating program, detects a malfunction and stops the operating program sequence in response, the fully automatic coffee maker 1 is operated in a data transmission mode.

In data transmission mode an encoding unit 3 of the fully automatic coffee maker 1 creates an encoded data record 5 from the data stored in the fault memory (not shown) of the fully automatic coffee maker 1. The QR code is used for this. In addition to data relating to measurement values from sensors of the of the hot beverage preparation apparatus and fault codes identifying its malfunctions and operating parameters of the hot beverage preparation apparatus, data is also encoded which allows automatic contact with the customer service department, namely the service number of the customer service department, for forwarding an automatically generated SMS.

The encoded data record 5 is then stored by way of data lines (not shown) in a data memory 6 of the fully automatic coffee maker 1. In a next step the encoded data record 5 is displayed on the display unit 4.

A receiving device 2, which is configured to read in data records 5 that have been optically encoded in this manner, reads in the encoded data record 5 and analyzes it. The receiving device 2 can be a mobile telephone, for example a smart phone, and can have an optical read device, for example a camera scanner, as well as corresponding software for processing said data. The receiving device 2 can generate an SMS automatically to inform the customer service department of the relevant fault without the operator having to decode a fault code or determine the service number of the customer service department.

If particularly large quantities of data have to be displayed, for example operating parameters, a number of encoded data records 5 can be stored in the data memory 6 and be displayed one after the other on the display unit 4. The receiving device 2 is then configured correspondingly to receive and process and number of data records 5.

### LIST OF REFERENCE CHARACTERS

1 Fully automatic coffee maker
2 Receiving device
3 Encoding unit
4 Display unit
5 Encoded data record
6 Data memory

1-10. (canceled)

11. A hot beverage preparation apparatus, which is configured for preparing hot beverages in a normal operating mode and for transmitting data to a receiving device in a data transmission mode, said hot beverage preparation apparatus comprising:
an encoding unit for encoding the data to form at least one encoded data record in a machine-readable code, and
a display unit for displaying the encoded data record.

12. The hot beverage preparation apparatus of claim 11, wherein the hot beverage preparation apparatus is a fully automatic coffee maker.

13. The hot beverage preparation apparatus of claim 11, wherein the encoded data record is encoded using a graphic code.

14. The hot beverage preparation apparatus of claim 13, wherein the graphic code is a 2D code

15. The hot beverage preparation apparatus of claim 11, wherein the encoded data record comprises data arranged in a one-dimensional matrix form arranged in a number of rows or in circles.

16. The hot beverage preparation apparatus of claim 11, wherein the encoded data record comprises at least one of measurement values from sensors of the hot beverage preparation apparatus, error codes identifying malfunctions of the hot beverage preparation apparatus, and operating parameters of the hot beverage preparation apparatus.

17. The hot beverage preparation apparatus of claim 11, wherein the encoded data record comprises a recipient address.

18. The hot beverage preparation apparatus of claim 11, wherein the encoded data record is configured for use with mobile tagging.

19. The hot beverage preparation apparatus of claim 11, wherein the display unit is a display.

20. The hot beverage preparation apparatus of claim 19, wherein the display is a TFT display.

21. The hot beverage preparation apparatus of claim 19, wherein the display unit is configured to time-sequentially display a plurality of encoded data records.

22. The hot beverage preparation apparatus of claim 16, further comprising a data memory for storing the encoded data record.
